(19) United States
(12) Patent Application Publication
(10) Pub. No.: US 2003/0210652 A1
(43) Pub. Date: Nov. 13, 2003

(54) Method and device for processing management information

(76) Inventor: Wen-Jie Chiang, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/431,904

(22) Filed: May 8, 2003

(30) Foreign Application Priority Data
May 9, 2002 (TW) 091109709

(51) Int. Cl. H04L 12/26

(52) U.S. Cl. 370/232; 370/254; 709/220; 709/223

(57) ABSTRACT

A method and a device for processing management information is disclosed. Firstly, a plurality of data packets are received from a network. Then, a plurality of management information data are generated in response to the plurality of data packets. Then, a control packet is generated according to the plurality of management information data. Afterwards, the control packet is transmitted to a driver by putting the control packet into the data packets.

### FIELD OF THE INVENTION

The present invention relates to a method and a device for processing management information, and more particularly to a method and a device for improving the efficiency of producing management information by using the internal control packet. The present invention also relates to a media access controller (MAC) for use in a network interface card.

### BACKGROUND OF THE INVENTION

A network interface card (NIC) interfaces between a host computer and a network cable, and includes a controller for coordinating the data exchange between the host computer and the network. In view of the host computer, the NIC functions for transferring data between memory and parallel data bus. In view of the network, on the contrary, the NIC functions for receiving/transmitting on-line data signals.

FIG. 1 is a schematic diagram illustrating data flow through a network interface card according to prior art. The network interface card 1 comprises a MAC 11 and a physical layer device (PHY) 12. The physical layer device 12 receives and converts packets from the network (not shown) into desired forms, such as digital forms, and then transmits them to the MAC 11. The MAC 11 comprises a plurality of registers for storing the packets according to their object groups or objects. These registers are also referred to as Management Information Base (MIB) registers. MIB consists of objects included in a network management base, and describes the essence of the objects. The management information data stored in the MIB registers are accessible by upper-level protocols such as the network communication protocol layer 3, and even the Simple Network Management Protocol (SNMP) 4 and other communication protocols 5. For example, if a printer on a network uses SNMP, the management information data may contain objects describing the operation of the printer from a network management standpoint, e.g., online/offline, paper available, tray empty, toner low, envelope tray empty, etc. Depending on the types of objects, the management information data can also include the number of received packets, number of transmitted data, colliding packets, CRC error, over-sized packets, under-sized packets, packet settings, packet parameters and/or specially defined packet particulars, which are suitable to be periodically counted and polled.

The MAC 11 further comprises a plurality of MIB counters (not shown) for counting the above management information data, and the counted data are stored in the MIB registers. When any MIB counter of the network interface card 1 is going to overflow, e.g. the counted value is reaching the capacity limit 65535 (FFFFh), the MAC 11 of the network interface card 1 will assert an interrupt signal to the driver 2. In response to the interrupt signal, the driver 2 outputs an I/O command to pick up and provide the management information data stored in the MIB register for the upper-level protocols such as the network communication protocol 3, and even the SNMP 4 and other communication protocols 5.

With the increasing demand of data communication, the bandwidth of networks is significantly increased to permit more data to be transmitted through networks. Via the network interface card 1, an increasing number of packets are transmitted to the driver 2. Meanwhile, more and more interrupt signals and corresponding I/O commands are asserted accordingly. Thus, the corresponding disadvantageousness is not only largely occupied CPU resources but also much burdened load of CPU. Furthermore, increasing numbers of MIB counters and registers are required, and too many MIB counters and MIB registers complicate the circuitry of the network interface card and increase the cost.

### SUMMARY OF THE INVENTION

It is an object of the present invention to provide a method for processing management information of a network interface card to improve the efficiency of network management.

It is another object of the present invention to provide a MAC that is used in a network interface card with simplified circuitry and reduced cost.

A first aspect of the present invention relates to a method for processing management information. When a number of data packets are received from a network, management information data are generated in response to the plurality of data packets. Then, a control packet is generated according to the plurality of management information data and transmitted to a driver by putting the control packet into the data packets.

In an embodiment, the network is Ethernet.

In an embodiment, the control packet is generated when at least one of the management information data has a count exceeding a threshold value. More specifically, the control packet includes the management information data having the count exceeding the threshold value.

In an embodiment, the method of the present invention further comprises a step of storing the control packet and the data packets in a main memory before the control packet and the data packets are transmitted to the driver, and the control packet is stored by using the direct memory access (DMA).

In an embodiment, the control packet is transmitted to a network communication protocol layer by the driver in response to a periodically querying operation of the network communication protocol layer.

In an embodiment, the control packet is transmitted to a network communication protocol layer by the driver in response to a periodically polling operation of the network communication protocol layer.

In an embodiment, the data packets are transmitted to a network communication protocol layer by the driver in response to an active access operation of the driver.

A second aspect of the present invention relates to a method for transmitting management information data from a network interface device to a network communication protocol layer, wherein the management information data is generated in response to data packets received by the network interface device. Firstly, a control packet is generated from one of the management information data when the one management information data has a count exceeding a threshold value. Then, the control packet is put into data packets to be transmitted by the network interface device. Then, the control packet is transmitted out of the network interface device along with the data packets, and storing the control packet in main memory and could be accessible by the network communication protocol layer.

In an embodiment, the method further comprises step of initializing the network interface device before the network interface device starts to receive data packets. Preferably, the step of initializing the network interface device comprising initializing pointer registers to realize the allocation thereof in the main memory.

In an embodiment, the control packet is generated when at least one of the MIB data exceeds a threshold value.

In an embodiment, the method of the present invention further comprises a step of periodically asserting a querying signal by the network communication protocol layer to access the control packet stored in the main memory via the driver. In another embodiment, the method of the present invention further comprises a step of periodically asserting a polling signal by the network communication protocol layer to access the control packet stored in the main memory via the driver.

A third aspect of the present invention relates to a MAC for transmitting data between a network and a computer. The MAC comprises a plurality of MIB counters, a control packet generator and a direct memory access engine. The plurality of MIB counters generate a plurality of management information data in response to a plurality of data packets received from the network. The control packet generator generates a control packet according to the plurality of management information data, the control packet being put into the data packets. The direct memory access engine stores the control packet in a main memory of the computer (which usually is called as DMA).

The network that the present controller is used with, for example, is Ethernet.

In an embodiment, the control packet is generated by the control packet generator when the MIB counters indicate at least one of the counted values of the management information data exceeds a threshold value.

In an embodiment, the MAC comprises a first and a second receiving pointer registers for pointing to a first and a second addresses where the received data packets and the control packet are to be stored in the main memory, respectively.

In an embodiment, the MAC further comprises a first and a second transmitting pointer registers for pointing to a third and a fourth addresses where the data packets to be transmitted and the control packet are stored in the main memory, respectively.

Preferably, the pointer registers are of a cyclic configuration.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating data flow through a network interface card according to prior art;

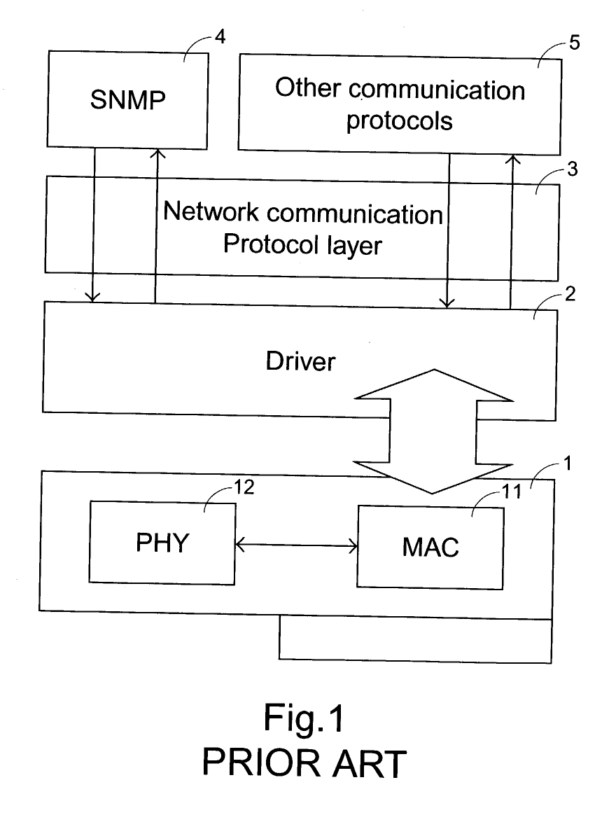

FIG. 2 is a schematic diagram illustrating data flow through a network interface card according to a preferred embodiment of the present invention; and

FIG. 3 is a schematic diagram illustrating transmission of control packets and data packets.

### DETAILED DESCRIPTION OF THE PREFERRED EMBODIMENT

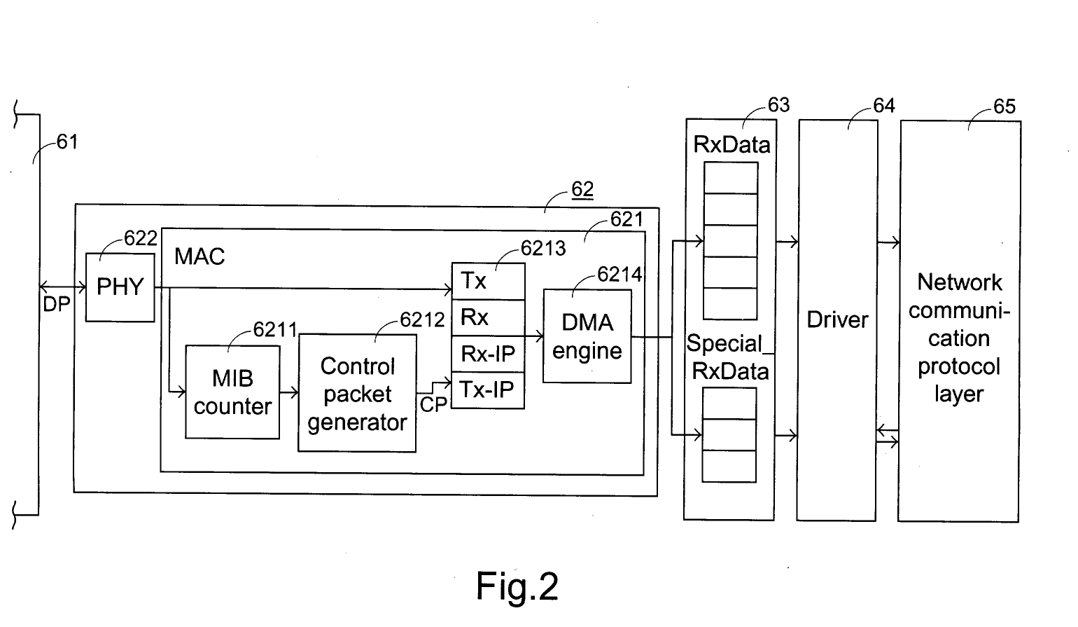

FIG. 2 is a schematic diagram illustrating data flow through a network interface card according to a preferred embodiment of the present invention. After data packets DP are received from Ethernet 61, these data packets DP are transmitted via a network interface card 62 to be stored in a main memory 63, and then further transmitted to a network communication protocol layer 65 by a driver 64.

The network interface card 62 comprises a MAC 621 and a physical layer device (PHY) 622. The physical layer device 622 receives and converts the data packets DP received from the Ethernet 61 into desired forms and then transmits them to the MAC 621. The MAC 621 comprises a plurality of MIB counters 6211, a control packet generator 6212, a pointer device 6213 and a direct memory access (DMA) engine 6214. In response to the receipt of the data packets DP, a plurality of management information data are generated from the MIB counters 6211. When at least one of the management information data has a count exceeding a threshold value, the control packet generator 6212 generates a control packet CP. Depending on the types of objects, various management information data are included in the control packet CP, for example the number of received packets, number of transmitted data, colliding packets, CRC error, over-sized packets, under-sized packets, packet settings, packet parameters and/or specially defined packet particulars, which are suitable to be periodically counted and polled.

For a purpose of increasing processing speed, the control packet CP is stored in the main memory 63 as well as the data packets DP by using the direct memory access via the DMA engine 6214. The pointer device 6213 comprises receiving pointer registers Rx and Rx_IP for pointing to corresponding addresses where the received data packets DP and the control packet DC are to be stored in the main memory 63, respectively. In addition, the pointer device 6213 comprises transmitting pointer registers Tx and Tx_IP for pointing to corresponding addresses where the data packets DP to be transmitted and the control packet DC are stored in the main memory 63, respectively.

Preferably, when the computer system is booted, the drive 64 disposes two specified regions RxData and Special_RxData in the main memory 63 for storing the data packets DP and the control packet CP, respectively. Meanwhile, the network interface card 62 is initialized, and the pointer registers of the pointer device 6213 are initialized to realize the allocation thereof in the main memory 63. The control packet CP is put into the data packets DP to be transmitted from the network interface card 62 to the memory 63. The data packet DP and the control packet CP are stored in the main memory 63 at the regions RxData and Special_RxData, respectively.

The pointer registers are preferably of a cyclic configuration and will increase progressively during operation of the MAC 621 so as to provide different approaches of receiving/transmitting data packets and control packet and avoid conflict therebetween.

Afterwards, the data packet DP and the control packet CP are transmitted to the driver 64 with different approaches. The data packets DP are transmitted to the network communication protocol layer 65 by the driver 64 in response to an active access operation of the driver. Whereas, the control packet CP is transmitted to the network communication protocol layer 65 by the driver in response to either a periodically querying operation or a periodically polling operation of the network communication protocol layer 65.

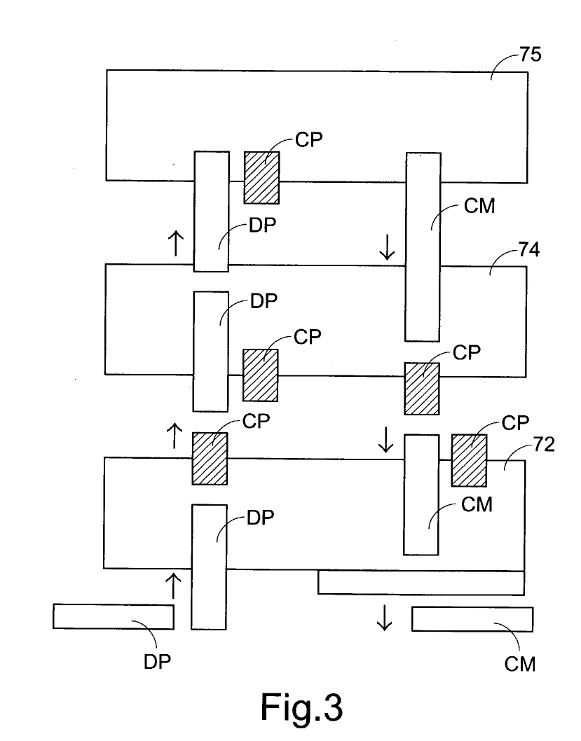

FIG. 3 schematically illustrates transmission of control packets CP and data packets DP in an open system interconnection (OSI) model. The first layer 72 of the OSI model is equivalent to the network interface card 62 in the embodiment of FIG. 2, and the second layer 74 is equivalent to the driver 64. The third to seventh layers, indicated by a numeral reference 75, are equivalent to upper-level application programs, e.g. the network communication protocol, the SNMP and other communication protocol layers. In a receiving procedure, the control packet CP is generated in the layer 72 and then put into the data packets DP to be transmitted to the layer 74. The data packets DP and the control packet CP are then respectively transmitted to the layer 75 via the layer 74. On the other hand, in a transmission procedure, the data packets DP asserted in the layer 74 is combined with the control packet CP and transmitted downwards. It is to be noted that only the control packet CP transmitted between the layer 72 or the network interface card 62 and the layer 74 or the driver 64 are transmitted according to the general packet transmission manner. For the transmission of the control packet CP from the layer 74 or the driver 64, it is conducted in response to the query or polling of the upper-level protocol layers 75 or the network communication protocol layer 65. In other words, the general packet flow is conducted just inside the system, and thus the resource utilization of CPU is efficient.

The method for transmitting management information data as described above has the following advantages when compared to the prior art.

Firstly, in place of asserting interrupt signals to have the driver assert an I/O command to pick the management information data only when any of the MIB counters is going to overflow, MAC generates a control packet including the management information data when at least one of the MIB counters has a counted value exceeding a threshold value. In addition, the network communication protocol layer obtains the management information data in a query or polling manner. Therefore, the CPU will not be redundantly occupied, and the efficiency of the network management is improved.

The control packet according to the present invention is put into the data packet stream, and stored in a specified region of the main memory rather than the MIB register. An MIB register is generally one to four bytes only for minimizing the gate counts of a network chip. Since the main memory has a much larger capacity than the MIB register in MAC, the control packet can be safely stored in the main memory until the system program needs or has time to pick it without any overflow problem. As such, the hardware resource can be efficiently distributed. Moreover, the hardware registers can be removed from the network interface card for circuitry simplification and cost reduction.

Since the control packet is of an internal essence, the realization of the management information data by the network communication protocol layer is unchanged as long as the driver retrieves the control packet as parameters recognized by the network communication protocol layer. In other words, there will be no need to modify the upper-level application programs in order to achieve the high performance associated with the lower-level layers.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for processing management information comprising steps of:
receiving a plurality of data packets from a network;
generating a plurality of management information data in response to said plurality of data packets;
generating a control packet according to said plurality of management information data; and
transmitting said control packet to a driver by putting said control packet into said data packets.

2. The method according to claim 1 wherein said network is Ethernet.

3. The method according to claim 1 wherein said control packet is generated when at least one of said management information data has a count exceeding a threshold value.

4. The method according to claim 3 wherein said control packet includes said management information data having said count exceeding said threshold value.

5. The method according to claim 1 further comprising a step of storing said control packet and said data packets in a main memory before said control packet and said data packets are transmitted to said driver, and said control packet is stored by using direct memory access.

6. The method according to claim 5 wherein said control packet is transmitted to a network communication protocol layer by said driver in response to a periodically querying operation of said network communication protocol layer.

7. The method according to claim 5 wherein said control packet is transmitted to a network communication protocol layer by said driver in response to a periodically polling operation of said network communication protocol layer.

8. The method according to claim 5 wherein said data packets are transmitted to a network communication protocol layer by said driver in response to an active access operation of said driver.

9. A method for transmitting management information data from a network interface device to a network communication protocol layer, said management information data being generated in response to data packets received by said network interface device, said method comprising steps of:
generating a control packet from one of said management information data when said one management information data has a count exceeding a threshold value;
putting said control packet into data packets to be transmitted by said network interface device; and
transmitting said control packet out of said network interface device along with said data packets, and storing said control packet in a main memory by using said direct memory access to be accessible by said network communication protocol layer.

10. The method according to claim 9 further comprising a step of initializing said network interface device before said network interface device starts to receive data packets.

11. The method according to claim 10 wherein said step of initializing said network interface device comprising initializing pointer registers to realize the allocation thereof in said main memory.

12. The method according to claim 9 wherein said control packet is generated when at least one management information base data exceeds a threshold value.

13. The method according to claim 9 further comprising a step of periodically asserting a querying signal by said network communication protocol layer to access said control packet stored in said main memory via said driver.

14. The method according to claim 9 further comprising a step of periodically asserting a polling signal by said network communication protocol layer to access said control packet stored in said main memory via said driver.

15. A media access controller for transmitting data between a network and a computer, comprising:
a plurality of management information base counters for generating a plurality of management information data in response to a plurality of data packets received from said network;
a control packet generator for generating a control packet according to said plurality of management information data; and
a direct memory access engine storing said control packet in a main memory of said computer and putting said control packet into said data packets.

16. The media access controller according to claim 15 wherein said network is Ethernet.

17. The media access controller according to claim 15 wherein said control packet is generated by said control packet generator when said management information base counters indicate at least one of the counted values of said management information data exceeds a threshold value.

18. The media access controller according to claim 15 further comprising a first and a second receiving pointer registers for pointing to a first and a second addresses where said received data packets and said control packet are to be stored in said main memory, respectively.

19. The media access controller according to claim 18 further comprising a first and a second transmitting pointer registers for pointing to a third and a fourth addresses where said data packets to be transmitted and said control packet are stored in said main memory, respectively.

20. The media access controller according to claim 19 wherein said pointer registers are of a cyclic configuration.
